(19) United States
(12) Patent Application Publication
(10) Pub. No.: US 2026/0003382 A1
(43) Pub. Date: Jan. 1, 2026

(54) BANDGAP REFERENCE CIRCUITS AND APPARATUSES

(71) Applicant: Intel Corporation, Santa Clara, CA (US)

(72) Inventors: Anupjyoti DEKA, Bangalore (IN); Shobhit TYAGI, Bangalore (IN); David DUARTE, Portland, OR (US); Sana SUMBUL, Vaishali (IN)

(21) Appl. No.: 18/756,805

(22) Filed: Jun. 27, 2024

(51) Int. Cl. G05F 3/30

(52) U.S. Cl. CPC G05F 3/30

(57) ABSTRACT

In some embodiments, bandgap reference circuits are provided that are capable of using PN junctions while transistors in the circuits can operate at reduced supply voltage levels.

### TECHNICAL FIELD

Embodiments of the invention relate to the field of integrated circuits; and more specifically, to the field of bandgap reference circuits.

### BRIEF DESCRIPTION OF THE DRAWINGS

The disclosure may best be understood by referring to the following description and accompanying drawings that are used to illustrate embodiments of the invention. In the drawings:

FIG. 1 is a block diagram showing an integrated circuit (IC) with bandgap reference (BGR) circuits in accordance with some embodiments.

FIG. 2 is a block diagram showing a BGR circuit architecture in accordance with some embodiments.

FIG. 3 is a circuit diagram showing a low drop-out (LDO) voltage regulator in accordance with some embodiments.

FIG. 4 is a circuit diagram showing a negative supply generation circuit in accordance with some embodiments.

FIG. 5 is a circuit diagram showing a BGR circuit in accordance with some embodiments.

FIG. 6 is a circuit diagram showing another example of a bandgap reference circuit in accordance with some embodiments.

FIGS. 7A-7C are diagrams showing signals in exemplary implementations of the circuits of FIGS. 4 and 6 in accordance with some embodiments.

FIG. 8 illustrates an example computing system having at least one bandgap reference circuit as discussed herein in accordance with some embodiments.

### DETAILED DESCRIPTION

On advanced process nodes, device reliability limits are scaling down. For example, with some processes, they have reduced down from transistors tolerating up to 1.08 V down to tolerating up to 0.96 V or even 0.91 V. However, bandgap circuits typically use PN junctions, e.g., from a PN junction diode. While transistor voltages are scaling down, diode voltages are not significantly changing, e.g., remaining near 0.85 V in some worst cases. This has required conventional low voltage bandgap circuit supplies to be at 1.05 V or higher as headroom (typically around 200 mV) may be needed for utilized current sources.

To overcome these conflicting requirements, conventional designs have used diode-less bandgap references that use transistors in sub-threshold regions instead of PN junctions to circumvent the headroom issue. Unfortunately, the accuracy of such bandgap circuits may be less than PN junction-based Bandgap circuits and are typically less robust due to heavy dependencies on accurate modelling of subthreshold parameters, leakage, and transistor threshold voltage dependencies with temperature. Accordingly, in some embodiments, bandgap circuits with PN junctions are provided that can operate with lower supply voltages that can meet existing, and even future process limits.

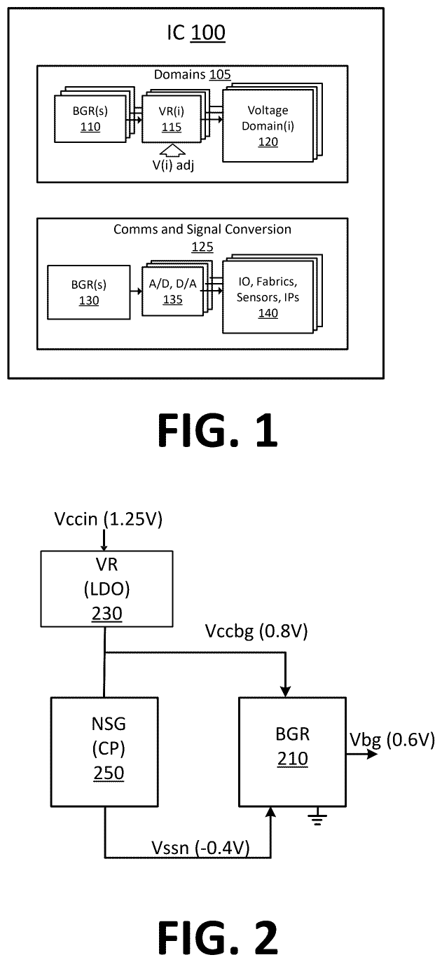

FIG. 1 is a block diagram showing an integrated circuit (IC) die 100 with bandgap reference (BGR) circuits in accordance with some embodiments. IC 100 may be any type of integrated circuit such as a processor IC (e.g., graphics processing unit [GPU], system on chip [SoC], applications processing unit [APU], accelerator, artificial intelligence processing unit [AIPU], etc.), a memory IC, an input/output extension IC, a radio frequency (RF) IC or the like.

The IC 100 includes a plurality of functional circuit domains 105 and/or a plurality of communications and signal conversion circuits 125, each of which may employ at least one bandgap reference circuit as described herein.

The functional domains 105 include one or more bandgap reference (BGR) circuits 110, one or more voltage regulators 115, and a plurality of voltage domain circuits 120, coupled together as shown. The voltage domain circuits 120 correspond to any of numerous functional blocks that may be used in an IC and have one or more different voltage rails supplying power to them. For example, a voltage domain 120 could include a core or core complex in a central processing unit (CPU), a GPU, an AIPU, etc.; an IP circuit block such as for a digital signal processor (DSP), a display engine, a security controller, a power management controller, a video processing unit, etc.; or it could correspond to other blocks such as for memory or input/output (IO) interfaces. Each voltage domain 120 is supplied with one or more regulated voltage supplies from a voltage regulator 115 such as a low drop out (LDO), a digital or hybrid LDO, a digital linear voltage regulator (DLVR), a switch capacitor VR, a buck/boost type VR, or the like. In order to provide a desired regulated voltage, the VR 115 uses a precise reference voltage generated by the one or more BGR circuits 110. The BGR circuits typically use PN junction based proportional to absolute temperature (PTAT) and complementary to absolute temperature (CTAT) elements to generate the precise reference voltage with as little temperature dependence as may be feasible. In some embodiments, the BGR circuits 110 use PN junctions with negative voltage biases to allow them to properly operate even with low circuit supply voltages.

The communications and signal conversion domains 125 include circuits such as IO fabrics and interfaces, sensors and other IP block circuits that rely upon precise, temperature independent voltage references. In the depicted embodiment, they use analog to digital (A/D) and digital to analog (D/A) converters 135 employing BGR circuits 130 as described herein.

FIG. 2 is a block diagram showing a BGR circuit architecture in accordance with some embodiments. The BGR generation circuit includes a BGR circuit 210, a voltage regulator 230, and a negative supply generation (NSG) circuit 250, coupled as shown.

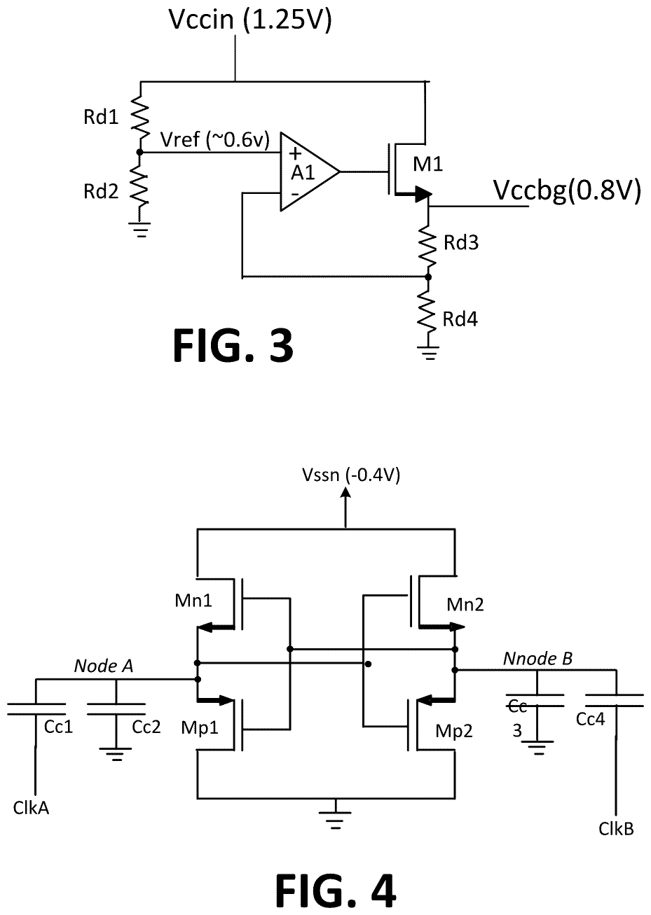

The VR 230 receives an input supply (Vccin) and generates from it a regulated supply voltage (Vccbg) for the BGR circuit 210. In some embodiments, the VR steps down the input supply (e.g., from 1.2V to 1.8V) to a lower BGR supply voltage (e.g., 0.6 V to 1.0 V). While any suitable circuit configuration may be used for the VR 230, in some embodiments, an LDO may be used. Not only are LDOs relatively compact and well-suited for IC applications, but also, they can provide good supply noise rejection for the bandgap supply (Vccbg). An example of an LDO circuit is shown in FIG. 3.

(Note that in the figures for this application, parenthesis may be used next to reference labels to identify a particular example or example value and should not be construed as limiting. Along these lines, the same reference labels, e.g., R1 or A1, may be used in different figures and should not be construed as being the same for all figures. A label in a given figure should not be interpreted or limited based on the same label being used in another figure except where otherwise indicated.)

The negative supply generation circuit 250 generates a negative supply voltage (Vssn) for the BGR circuit 210. In the depicted embodiment, the NSG 250 receives as a supply input the bandgap reference supply (Vccbg) generated by VR 230 and generates from it a negative supply (Vssn) provided to the BGR circuit 210. Any suitable circuit capable of generating a negative supply may be used for the NSG 250. In some embodiments, a charge pump circuit may be employed. An example of a suitable charge pump circuit is shown in FIG. 4.

The BGR circuit 210 generates a bandgap reference voltage (Vbg) using the provided supply references, Vccbg as a high supply reference and Vssn as a low supply reference. With a negative supply reference (e.g., −0.4 V or so), a lower high supply reference, e.g., Vccbg less than 0.9 V may be used with utilized PN junctions (e.g., diode or transistor PN junctions) that can still be sufficiently activated. With lower high side supply references, the complexity of using thick gate devices may be avoided without having to use CMOS-only bandgap reference circuits not using PN junctions.

In some embodiments, the use of negative supplies may be better facilitated with transistors such as gate-all-around (GAA) transistors where it is not unusual for their bulks (or substrates) to be decoupled from their transistor source terminals. This allows for manufacturers to avoid having to use deep N-well and/or P-well (depending on semiconductor process) isolation that may otherwise be required for negative supplies.

FIG. 3 is a circuit diagram showing an LDO in accordance with some embodiments. The LDO may be used as a VR 230 for the BGR circuit of FIG. 2. The LDO includes a differential amplifier (A1), transistor M1 (N-type metal oxide semiconductor transistor in this example), and resistors Rd1 through Rd4, coupled as shown. The LDO receives an input supply (Vccin), which may be a relatively higher voltage, e.g., above 1.0 V (1.25 V in the example) and generates from it a stepped-down output supply voltage (Vccbg) for a bandgap reference circuit. In the depicted example, the output voltage (Vccbg) is at 0.8 V.

Resistors Rd1 and Rd2 function as voltage dividers, providing to a non-inverting input of amplifier (A1) a reference of about 0.6 V. The circuit output (Vccbg) is at the source of M1. Resistors Rd3 and Rd4 are coupled together between this output at one end of Rd3 and at a ground reference at one end of Rd4. They are coupled to each other at a resistor junction that is also coupled to an inverting input of amplifier (A1). In this way, resistors Rd3 and Rd4 provide negative feedback from the out to the amplifier causing the junction node to equal the reference voltage (Vref). Since Rd3 is between the feedback junction and the output, the output value (Vccbg) will approximately equal Vref(Rd3+Rd4)/Rd4, providing a regulated and raised voltage relative to the reference voltage. In the depicted example, with the reference voltage (Vref) at about 0.6 V, the Rd3 and Rd4 resistors are sized to provide an output (Vccbg) of about 0.8 V.

FIG. 4 is a circuit diagram showing a negative supply generation circuit in accordance with some embodiments. In this example, the NSG circuit is a charge pump circuit formed from N-type transistors (Mn1, Mn2), P-type transistors (Mp1, Mp2) and capacitors Cc1 through Cc4 coupled together, as shown. The circuit also includes clock sources to provide complementary clock signals (ClkA, ClkB) coupled to capacitors Cc1 and Cc4 to drive the charge pump circuit. In the depicted example, for a −0.4 V Vssn output, first and second clock signals (ClkA, ClkB) that are 180 degree out-of-phase and toggle between 0V and 0.8 V, at a frequency of 100 MHz, may be employed. These clock signals are used to power the charge pump circuit, supplying to them current through their capacitive inputs.

The charge pump circuit uses the capacitors (Cc1-Cc4) to generate the negative voltage supply at its output (Vssn). In some embodiments, the capacitances for the capacitors may be the same and need not necessarily be large. For example, in some embodiments, Cc1-Cc4 may be 10 pF or less when BGR PN junction current is sufficiently small, e.g., in the neighborhood of 25 uA. Any suitable capacitor type may be used such as metal fringe capacitors (MFCs), e.g., in close proximity with the BGR diodes, and other capacitor types including metal-oxide-semiconductor (MOS) capacitors, metal-insulator-metal (MIM) capacitors, and/or deep trench capacitors, which if desired, can provide higher capacitance densities in a relatively small area.

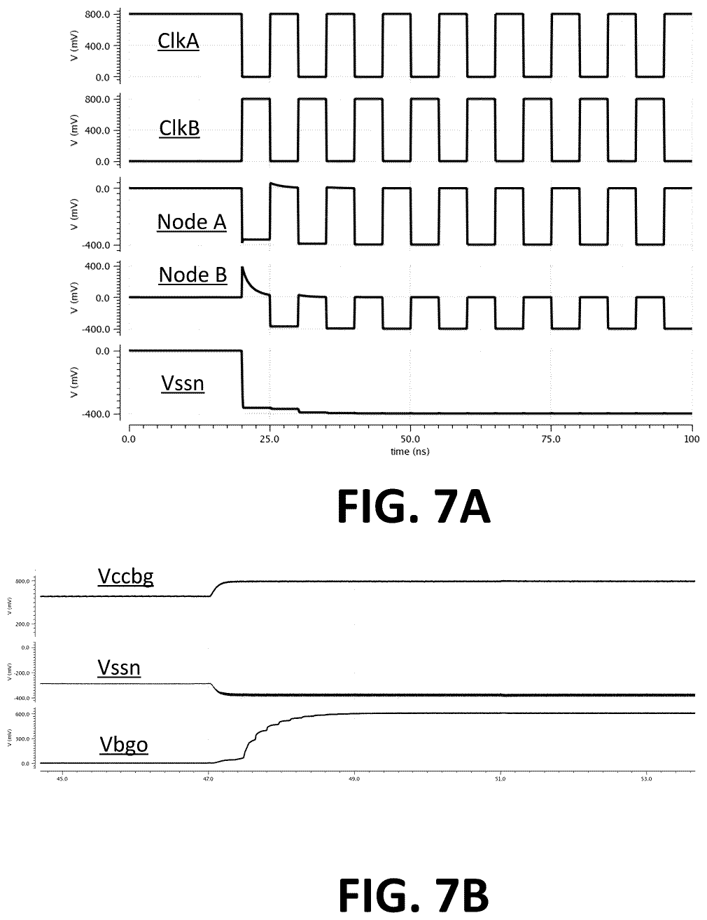

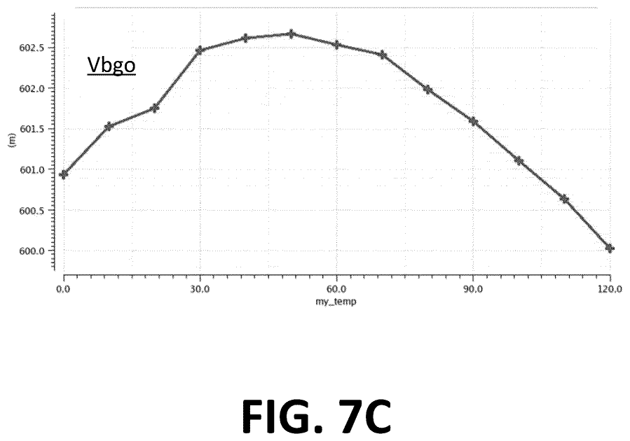

With additional reference to charge pump signal diagrams in FIG. 7A, operation of the charge pump circuit will be described. With this example, the clocks are configured to be 180 degrees out-of-phase with equivalent 50% duty cycles. Assume that for the first clock phase, ClkA is High and ClkB is Low. Conversely, for the second clock phase, ClkA is Low and ClkB is High. During the first clock phase (ClkA High at 0.8 V, ClkB Low at 0 V), node A is drawn to ground by Cc2 while Cc1 is charged. When the clock transitions to the second phase (ClkA dropping to 0 V), the 0.8 drop across Cc1 causes Node A to go to −0.4 V as a result of capacitive voltage division. During this time, Mn1 turns on, discharging the −0.4 V from Node A to the output at Vssn. Similarly, during the second phase, node B is pulled down to 0V and then when the clock switches back to the first phase, Node B is pushed to −0.4 V through capacitive division. This time, Mn2 turns on, discharging the −0.4 V at Node B to the output at Vssn. In this way, a sustained negative supply (in this case −0.4 V) may be provided to the BGR through the charge pump output at Vssn.

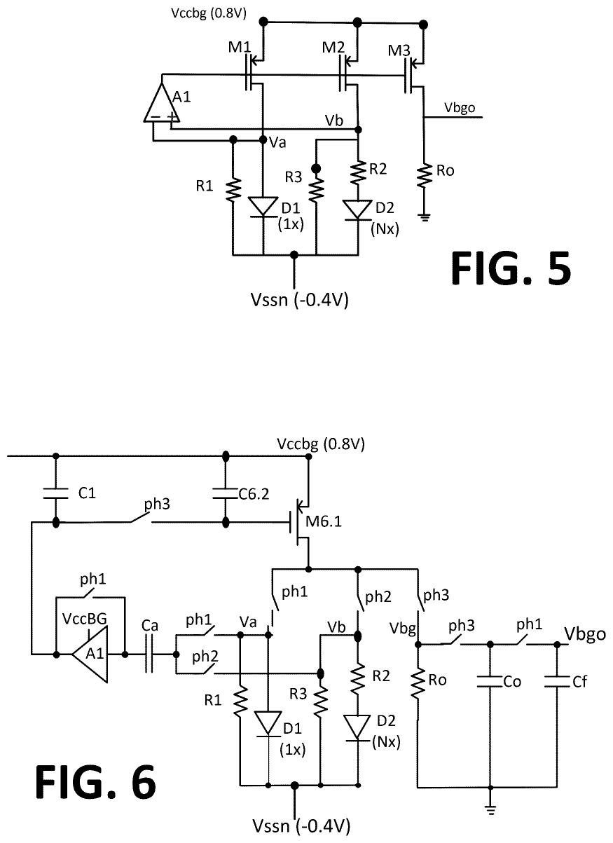

FIG. 5 is a circuit diagram showing a BGR circuit in accordance with some embodiments. The BGR circuit includes amplifier (A1); transistors M1, M2, M3; resistors R1, R2 and PN junctions formed from diodes D1, D2, all coupled together as shown. The circuit includes first and second PN junctions formed from diodes D1, D2 to provide both PTAT (proportional to absolute temperature) and CTAT (complementary to absolute temperature) elements.

In operation, the amplifier A1 operates to equalize the voltages at Va and Vb, which results in a PTAT current in R2 proportional to the voltage difference between Va and Vb. At the same time, this is offset by CTAT currents in R1 and R3. They counter each other such that the current in M3, under ideal conditions, remains constant over changes in temperature and thereby generates a reasonably temperature-stable voltage (Vbgo) at Ro, the value of which may be defined by designing for a suitable Ro current in combination with the value of R3 itself. In some embodiments, the value of Ro may be trimmed to precisely tune the Vbgo value.

For this to work properly, however, diodes D1 and D2 should be allowed to operate over their voltage ranges with respect to the specified operating temperature range. In some embodiments, this may go up to 0.85 V, even as tolerable voltages for scaled down transistors are reduced, e.g., limits of between 0.7 and 0.9 V. Accordingly, in order to allow diodes D1 and D2 to operate properly, the negative supply (Vssn) is used as a low supply reference on their cathode sides. At the same time, the amplifier and output resistor may use ground as their lower supply references.

FIG. 6 is a circuit diagram showing another example of a PN-based bandgap reference circuit in accordance with some embodiments. This example may perform better, in some ways under certain conditions, than the BGR of FIG. 5 because it does not depend on accurate matching between current sources (as with M1, M2 and M3 in FIG. 5.

The depicted BGR of FIG. 6 includes amplifier A1, capacitors: Ca, C1, C2, Co, Cf, resistors: R1, R2, R3, Ro, Rf, transistor M1, switches: ph1, ph2, ph3, and diodes D1, D2, all coupled together as shown. The phase switches may be implemented with any suitable circuit switching element such as single transistors or pass gates. They are controlled using three synchronized phases of a clock cycle, e.g., ph1 (0 degrees, 25% clock cycle), ph2 (90 degrees, 25% clock cycle), ph3 (180 degrees, 50% clock cycle). In this way, the switches are interleaved relative to one another with ph1 on for 25%, ph2 on for 25% and ph3 on for 50%. While a 25:25:50 duty cycle ratio is employed in this example, it should be appreciated, however, that any suitable switch phase ratio in cooperation with the selected capacitors may be used. For example, a 33:33:33 duty cycle may be used in some embodiments.

The switching effectively causes Amplifier A1 and capacitors Ca, C1, and C2 to work to equalize the voltage levels at Va and Vb. From here, the circuit operates with PTAT/CTAT components, similar to the BGR circuit of FIG. 5, except that it doesn't depend on current source transistors M1, M2, and M3 being matched with each other.

The output (Vbgo) of the bandgap circuit is given by the following equation:

$$Vbg = R \times ( \frac{Va}{R 1} + \frac{{nV}_{t} ln ( N )}{R 2} )$$

where N is the current density ratio between D2 and D1, Vₜ is the PN junction thermal voltage and n is a scaling factor. This equation incorporates a combination of a positive temperature correlated term, ηVT ln(N), with a negative temperature correlated diode voltage Va to yield the temperature independent reference.

When a charge pump such as the charge pump of FIG. 4 is used, depending on the load current flowing through Vssn into Nodes A, B of the charge pump, the charge pump output may have a small ripple as shown in FIG. 7B. However, with the use of filter capacitor Cf, this ripple may be filtered out at the bandgap output Vbgo. FIG. 7C is a signal diagram showing a trimmed bandgap output (Vbgo) as a function of temperature for the BGR of FIG. 6.

Note that the absolute DC voltage of the negative charge pump output (Vssn) should not materially impact the final bandgap voltage as the current value in which the bandgap loop converges to achieve equal Va and Vb is independent of this DC level.

In order to address possible reliability issues, the utilized VR (LDO) may be configured to provide a lower voltage during a powered down state. When the bandgap is turned off during standby, the voltage across the diodes may be at 0V. In such a power state, if the charge pump is at −0.4 V and the BGR input supply (Vccbg) is active, e.g., at 0.8 V, an intolerable drop (e.g., 1.2 V) may be imposed on M1. Accordingly, in some embodiments, in order to avoid reliability risks during that time, the LDO may be kept in a unity gain configuration, e.g., with a 0.6 V output. With the depicted embodiment, this also causes the charge pump output to be at −0.3 V. So the maximum voltage across any device in this scenario would be less than 0.9 V.

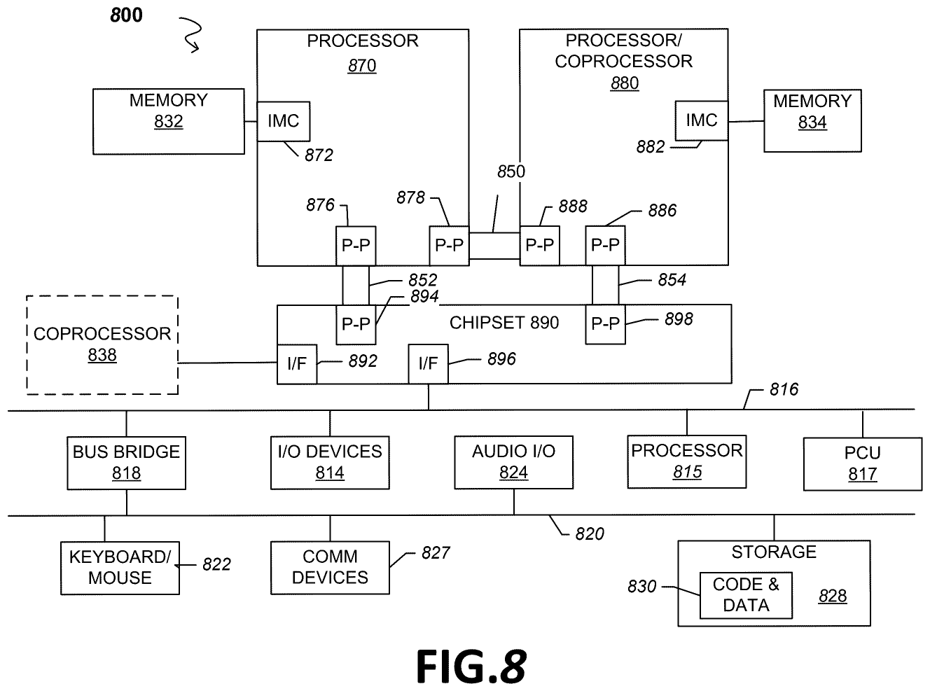

FIG. 8 illustrates an example computing system having at least one bandgap reference circuit as discussed herein in accordance with some embodiments. Multiprocessor system 800 is an interfaced system and includes a plurality of processors including a first processor 870 and a second processor 880 coupled via an interface 850 such as a point-to-point (P-P) interconnect, a fabric, and/or bus. In some examples, the first processor 870 and the second processor 880 are homogeneous. In some examples, first processor 870 and the second processor 880 are heterogenous. Though the example system 800 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 870 and 880 are shown including integrated memory controller (IMC) circuitry 872 and 882, respectively. Processor 870 also includes interface circuits 876 and 878, along with core sets. Similarly, second processor 880 includes interface circuits 886 and 888, along with a core set as well. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 870, 880 may exchange information via the interface 850 using interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a network interface (NW I/F) 890 via individual interfaces 852, 854 using interface circuits 876, 894, 886, 898. The network interface 890 (e.g., one or more of an interconnect, bus, and/or fabric, and in some examples is a chipset) may optionally exchange information with a coprocessor 838 via an interface circuit 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via an interface such as P-P interconnect, such that either or both processors' local cache information may be stored in the shared cache if a processor is placed into a low power mode.

Network interface 890 may be coupled to a first interface 816 via interface circuit 896. In some examples, first interface 816 may be an interface such as a Peripheral Component Interconnect (PCI) interconnect, a PCI Express interconnect, or another I/O interconnect. In some examples, first interface 816 is coupled to a power control unit (PCU) 817, which may include circuitry, software, and/or firmware to perform power management operations with regard to the processors 870, 880 and/or co-processor 838. PCU 817 provides control information to one or more voltage regulators (not shown) to cause the voltage regulator(s) to generate the appropriate regulated voltage(s), in some cases, using bandgap reference circuits as described herein. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 814 may be coupled to first interface 816, along with a bus bridge 818 which couples first interface 816 to a second interface 820. In some examples, one or more additional processor(s) 815, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 816. In some examples, second interface 820 may be a low pin count (LPC) interface. Various devices may be coupled to second interface 820 including, for example, a keyboard and/or mouse 822, communication devices 827 and storage circuitry 828. Storage circuitry 828 may be one or more non-transitory machine-readable storage media as described below, such as a disk drive or other mass storage device which may include instructions/code and data 830 and may implement the storage in some examples. Further, an audio I/O 824 may be coupled to second interface 820. Note that other architectures than the point-to-point architecture described above are possible. For example, instead of the point-to-point architecture, a system such as multiprocessor system 800 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

Illustrative examples of the technologies disclosed herein are provided below. An embodiment of the technologies may include any one or more, and any compatible combination of, the examples described below.

Example 1 is an integrated circuit (IC) apparatus that includes a bandgap reference circuit and a negative supply generation circuit. The bandgap reference (BGR) circuit has a positive supply reference node and a negative supply reference node. The negative supply generation circuit has an output node coupled to the negative supply reference node.

Example 2 includes the subject matter of example 1, and wherein the BGR circuit has a transistor with a first node coupled to the positive supply reference node.

Example 3 includes the subject matter of any of examples 1-2, and wherein the transistor has a second node coupled to an anode of a first PN junction.

Example 4 includes the subject matter of any of examples 1-3, and wherein the PN junction is part of a diode.

Example 5 includes the subject matter of any of examples 1-4, and comprising a resistor in series with a second PN junction, the resistor and second PN junction coupled between the second node, through a switch, and the negative supply reference node.

Example 6 includes the subject matter of any of examples 1-5, and wherein the second node is coupled to the anode of the first PN junction through a switch.

Example 7 includes the subject matter of any of examples 1-6, and comprising an output resistor coupled between an output bandgap voltage node and a ground reference node.

Example 8 includes the subject matter of any of examples 1-7, and wherein the output bandgap voltage node is coupled to the second node through a switch.

Example 9 includes the subject matter of any of examples 1-8, and wherein the negative supply generation circuit is a charge pump circuit having a supply node coupled to the positive supply reference node.

Example 10 includes the subject matter of any of examples 1-9, and wherein the positive supply reference node is coupled to an output of a low drop-out voltage regulator.

Example 11 is an apparatus that includes one or more current sources, a first diode coupled between a first one of the one or more current sources, a negative supply reference node, and an output node coupled to the first diode to provide a bandgap reference voltage.

Example 12 includes the subject matter of example 11, and comprising a first resistor coupled between at least one of the one or more current sources and a ground reference node.

Example 13 includes the subject matter of any of examples 11-12, and comprising a second resistor in series with a second diode, the second resistor and second diode coupled between at least one of the one or more current sources and the negative supply reference node.

Example 14 includes the subject matter of any of examples 11-13, and wherein the first diode, the second resistor in series with the second diode, and the first resistor are each coupled to the first current source through a separate switch.

Example 15 includes the subject matter of any of examples 11-14, and wherein the first diode is coupled to the first current source, the second resistor in series with the second diode is coupled to a second current source, and the first resistor is coupled to a third current source.

Example 16 includes the subject matter of any of examples 11-15, and wherein the one or more current sources are implemented with at least one gate-all-around transistor.

Example 17 includes the subject matter of any of examples 11-16, and wherein the negative supply reference node is coupled to a negative supply generation circuit supplied by a positive supply provided to the one or ore current sources.

Example 18 is a system that includes a processor IC and a memory IC. The processor IC includes a bandgap reference (BGR) circuit having a positive supply reference node and a negative supply reference node, a negative supply generation circuit having an output node coupled to the negative supply reference node, at least one voltage regulator circuit having: (i) a VR input node coupled to the bandgap reference circuit to receive from it a bandgap reference voltage and (ii) a VR output node, and a functional domain circuit having a domain supply input node coupled to the VR output node. The one or more memory ICs are coupled to the processor IC.

Example 19 includes the subject matter of example 18, and wherein the BGR circuit has a transistor with a first node coupled to the positive supply reference node.

Example 20 includes the subject matter of any of examples 18-19, and wherein the transistor has a second node coupled to an anode of a first PN junction.

Example 21 includes the subject matter of any of examples 18-20, and wherein the PN junction is part of a diode.

Example 22 includes the subject matter of any of examples 18-21, and comprising a resistor in series with a second PN junction, the resistor and second PN junction coupled between the second node, through a switch, and the negative supply reference node.

Example 23 includes the subject matter of any of examples 18-22, and wherein the second node is coupled to the anode of the first PN junction through a switch.

Example 24 includes the subject matter of any of examples 18-23, and comprising an output resistor coupled between an output bandgap voltage node and a ground reference node, the output bandgap voltage node to provide the bandgap reference voltage.

Example 25 includes the subject matter of any of examples 18-24, and wherein the output bandgap voltage node is coupled to the second node through a switch.

Example 26 includes the subject matter of any of examples 18-25, and wherein the negative supply generation circuit is a charge pump circuit having a supply node coupled to the positive supply reference node.

Example 27 includes the subject matter of any of examples 18-26, and wherein the processor IC and memory IC are part of a multi-chip module.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The terms “in series with” or similar indicate a serial connection between two or more components where the connection can be based on a direct or indirect connection between the two or more components.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, a system on a chip (SoC), an application processor, an integrated circuit incorporating a combination of one or more of the aforesaid items, etc.

While the invention has been described in terms of several embodiments, those skilled in the art will recognize that the invention is not limited to the embodiments described, can be practiced with modification and alteration within the spirit and scope of the appended claims. For example, The above architecture could also be used for a digital temperature sensor (DTS) where the negative supply is provided to remote temperature sensing diodes in an IC so that a diode anode voltage may stay below a ground level and converted to a temperature code with a circuit using a Vccbg supply (e.g., a supply less than 0.9 V). The description is thus to be regarded as illustrative instead of limiting.

What is claimed is:

1. An apparatus, comprising
a bandgap reference (BGR) circuit including a positive supply reference node and a negative supply reference node; and
a negative supply generation circuit including an output node coupled to the negative supply reference node.

2. The apparatus of claim 1, wherein the BGR circuit further comprises a transistor with a first node coupled to the positive supply reference node.

3. The apparatus of claim 2, wherein the transistor has a second node coupled to an anode of a first PN junction.

4. The apparatus of claim 3, wherein the PN junction is part of a diode.

5. The apparatus of claim 3, comprising a resistor in series with a second PN junction, the resistor and second PN junction coupled between the second node, through a switch, and the negative supply reference node.

6. The apparatus of claim 3, wherein the second node is coupled to the anode of the first PN junction through a switch.

7. The apparatus of claim 3, comprising an output resistor coupled between an output bandgap voltage node and a ground reference node.

8. The apparatus of claim 7, wherein the output bandgap voltage node is coupled to the second node through a switch.

9. The apparatus of claim 1, wherein the negative supply generation circuit is a charge pump circuit having a supply node coupled to the positive supply reference node.

10. The apparatus of claim 1, further comprising a processor including one or more of the bandgap reference and negative supply generation circuits.

11. An apparatus, comprising:
one or more current sources;
a first diode coupled between a first one of the one or more current sources and a negative supply reference node; and
an output node coupled to the first diode to provide a bandgap reference voltage.

12. The apparatus of claim 11, comprising a first resistor coupled between at least one of the one or more current sources and a ground reference node.

13. The apparatus of claim 12, comprising a second resistor in series with a second diode, the second resistor and second diode coupled between at least one of the one or more current sources and the negative supply reference node.

14. The apparatus of claim 13, wherein the first diode, the second resistor in series with the second diode, and the first resistor are coupled to the first current source through a separate switch.

15. The apparatus of claim 13, wherein the first diode is coupled to the first current source, the second resistor in series with the second diode is coupled to a second current source, and the first resistor is coupled to a third current source.

16. The apparatus of claim 11, wherein the one or more current sources are implemented with at least one gate-all-around transistor.

17. The apparatus of claim 11, wherein the negative supply reference node is coupled to a negative supply generation circuit supplied by a positive supply provided to the one or more current sources.

18. The apparatus of claim 11, further comprising a processor including at least one bandgap reference circuit comprising the one or more current sources, the first diode, and
the output node.

19. A system, comprising
a processor including:
a bandgap reference (BGR) circuit having a positive supply reference node and a negative supply reference node,
a negative supply generation circuit having an output node coupled to the negative supply reference node,
at least one voltage regulator circuit having: (i) a VR input node coupled to the bandgap reference circuit to receive from it a bandgap reference voltage and (ii) a VR output node, and
a functional domain circuit having a domain supply input node coupled to the VR output node; and
one or more memories coupled to the processor.

20. The system of claim 19, wherein the BGR circuit has a transistor with a first node coupled to the positive supply reference node and the transistor has a second node coupled to an anode of a first PN junction.
